(19) United States
(12) Patent Application Publication
(10) Pub. No.: US 2026/0339736 A1
(43) Pub. Date: Oct. 29, 2026

(54) Transformer LLM Disaggregation for Heterogeneous Processing Units

(71) Applicant: TurboNext.ai Ltd., Singapore (SG)

(72) Inventors: Rolf Muralt, Palo Alto, CA (US); Shang-Tse Chuang, Taipei (TW); Sharad Vasantrao Chole, San Mateo, CA (US); Costas Calamvokis, Bath (GB); Siyad Chih-Hua Ma, Palo Alto, CA (US); Joonsuk Bae, Menlo Park, CA (US); Viktor Puš, Kurim (CZ); Athish Rahul Rao, San Jose, CA (US)

(21) Appl. No.: 19/647,709

(22) Filed: Apr. 14, 2026

Related U.S. Application Data
(60) Provisional application No. 63/795,128, filed on Apr. 25, 2025.
(60) Provisional application No. 63/795,120, filed on Apr. 25, 2025.
(60) Provisional application No. 63/795,138, filed on Apr. 25, 2025.

(51) Int. Cl. G06F 9/50; G06N 3/0499

(52) U.S. Cl. CPC G06F 9/5038; G06N 3/0499

(57) ABSTRACT

A method and apparatus execute inference for a large language model across heterogeneous processing elements. A first processing element of a first type stores model weights and executes a first computational part of the model. A second processing element having a type or resource profile different from that of the first processing element stores session-specific state and executes a second computational part of the model. A scheduler characterizes resource attributes of each processing element and selects a placement plan that assigns computational parts to respective processing elements based on their resource profiles. Intermediate results are transmitted between the processing elements via an interconnect interface coupling the first processing element and the second processing element. Output tokens are assembled from combined results of the computational parts, completing the inference request.

### CROSS-REFERENCE TO RELATED APPLICATIONS

This application claims the benefit and priority of U.S. Provisional Application No. 63/795,128, filed Apr. 25, 2025, entitled "Transformer LLM Disaggregation for Heterogeneous Processing Units," U.S. Provisional Application No. 63/795,120, filed Apr. 25, 2025, entitled "System and Method for Physical Disaggregation of Memory and Compute in Large Language Model Serving," and U.S. Provisional Application No. 63/795,138, filed Apr. 25, 2025, entitled "Distributed Processing of Large Language Models and Other Neural Network Workloads Using a Modular, Dynamically Reconfigurable Interconnection Fabric," each of which is hereby incorporated by reference herein in its entirety.

This application is also related to U.S. Patent Application No. [__/__,___], filed [DATE], entitled “System and Method for Physical Disaggregation of Memory and Compute in Large Language Model Serving,” and U.S. Patent Application No. [__/__,___], filed [DATE], entitled “Distributed Processing of Large Language Models and Other Neural Network Workloads Using a Modular, Dynamically Reconfigurable Interconnection Fabric,” each of which is hereby incorporated by reference herein in its entirety.

### FIELD

The present disclosure relates generally to inference serving systems for large language models (LLMs), and more particularly to methods and apparatus for disaggregating Transformer model computation across heterogeneous processing elements including graphics-processing units (GPUs), neural-processing units (NPUs), language-processing units (LPUs), and other specialized processing elements.

### BACKGROUND

Large language models based on the transformer architecture are served by inference systems that distribute computation across clusters of graphics-processing units using pipeline-parallel and tensor-parallel partitioning schemes. These partitioning schemes require every graphics-processing unit in the cluster to be identical in architecture, memory capacity, interconnect width, and arithmetic throughput. During autoregressive decoding, the workload transitions from compute-bound to memory-bound: each output token requires substantial random memory reads from the key-value cache but only modest arithmetic computation. Because each graphics-processing unit in a tensor-parallel cluster stores a replica of the user-specific key-value cache in local high-bandwidth memory, the high-bandwidth memory capacity consumed by key-value caches scales linearly with the number of concurrent sessions. High-bandwidth memory on each graphics-processing unit therefore saturates with per-session key-value cache state while the arithmetic units of the graphics-processing unit sit idle.

Because high-bandwidth memory is an order of magnitude more expensive and more power-hungry than commodity dynamic-random-access memory, a cluster sized for large-scale multi-tenant inference incurs high first-token latency, high inter-token latency, and a total cost of ownership that grows super-linearly with concurrency. Furthermore, tensor-parallel partitioning imposes all-synchronization barriers at every layer boundary, such that the slowest graphics-processing unit in the cluster gates forward progress for every other graphics-processing unit, and any heterogeneity in hardware vendor, hardware generation, clock frequency, or interconnect width causes the faster graphics-processing units to stall.

### SUMMARY OF THE DISCLOSURE

In one aspect, a method of executing inference in a heterogeneous serving system for a large language model includes receiving an inference request that includes a sequence of input tokens for a user session; characterizing, for each of a plurality of processing elements that include at least a first processing element and a second processing element having a type or resource profile different from that of the first processing element, respective resource attributes comprising on-chip memory, off-chip memory bandwidth, and arithmetic throughput; decomposing the model into a plurality of computational parts that differ in their memory and arithmetic demands; selecting, by a scheduler that consults the resource attributes, a placement plan that assigns at least a first computational part to the first processing element and a second computational part to the second processing element; executing the assigned computational parts on their respective processing elements; transmitting intermediate results between the first processing element and the second processing element via an interconnect interface coupling the first processing element and the second processing element; and assembling one or more output tokens from combined results of the computational parts, completing the inference request.

In another aspect, an apparatus for serving inference requests to a large language model includes a first processing element of a first type and having a first memory adapted to store model weights and to execute a first computational part of the model; a second processing element having a type or resource profile different from that of the first processing element and having a second memory, distinct from the first memory, adapted to store session-specific state and to execute a second computational part of the model; an interconnect interface coupling the first and second processing elements and dimensioned to transfer intermediate results between them; and a scheduler circuit or executable control logic configured to obtain resource attributes for each processing element, assign computational parts of the model to processing elements based on the resource attributes, and coordinate execution of the assigned computational parts so that, in response to an inference request, the apparatus produces one or more output tokens.

### BRIEF DESCRIPTION OF THE DRAWINGS

FIG. 1 is a block diagram of a heterogeneous serving system for serving inference requests to a large language model, according to an embodiment.

FIG. 2 is a block diagram of a prior-art homogeneous graphics-processing-unit cluster using tensor parallelism.

FIG. 3 is a diagram illustrating a tensor-parallel decomposition of a weight matrix across a plurality of graphics-processing units in the homogeneous cluster of FIG. 2.

FIG. 4 is a block diagram illustrating a decomposition of a Transformer block into computational snippets with resource-demand metadata, according to an embodiment.

FIG. 5 is a system architecture diagram illustrating a heterogeneous graphics-processing-unit-only (GPU-only) cluster in which computational snippets are dispatched across graphics-processing units of different types, according to an embodiment.

FIG. 6 is a system architecture diagram illustrating a heterogeneous graphics-processing-unit (GPU) and neural-processing-unit (NPU) system in which a GPU sub-cluster containing a plurality of individually labeled graphics-processing units executes feed-forward layers in a tensor-parallel configuration and an NPU bank executes attention layers and stores the key-value cache, according to an embodiment.

FIG. 7 is a diagram illustrating a resource characterization matrix 508 and a scheduler circuit or executable control logic 112 within the optimization layer 114 for selecting placement plans, according to an embodiment.

FIG. 8 is a system architecture diagram illustrating the position of an optimization layer within a software stack of the heterogeneous serving system, according to an embodiment.

FIG. 9 is a table listing representative model architectures supported by the computational snippet decomposition of FIG. 4, according to an embodiment.

FIG. 10 is a system architecture diagram illustrating a network-fabric disaggregation embodiment in which first processing elements and second processing elements reside in separate chassis coupled by a Clos switching fabric, according to an embodiment.

FIG. 11 is a flowchart illustrating a method of executing inference in the heterogeneous serving system, according to an embodiment.

FIG. 12 is a schematic diagram of an example computer system that can be used in embodiments of the present disclosure.

### DETAILED DESCRIPTION OF EXAMPLE EMBODIMENTS

A heterogeneous serving system for a large language model (LLM) decomposes each Transformer block into functionally distinct computational parts (also referred to herein as computational snippets) and dispatches those computational parts across a plurality of processing elements that differ in at least one of architecture, vendor, generation, or memory type. The computational parts differ in their memory and arithmetic demands. The computational parts include at minimum a token-embedding snippet, an attention snippet, a feed-forward network snippet, and a residual-norm snippet, each annotated with resource-demand metadata describing at least compute density and memory bandwidth requirements. Feed-forward layers of the model execute on a first processing element such as a graphics-processing unit (GPU) having high arithmetic throughput, while, in some embodiments, an attention layer of the model and an associated key-value cache reside on a second processing element such as a neural-processing unit (NPU), a language-processing unit (LPU), or a second graphics-processing unit having a resource profile better matched to the attention layer. An interconnect interface couples the first and second processing elements and is dimensioned to transfer intermediate results (such as attention results) without transferring the key-value cache to the first processing element.

As used herein, the term “processing element” refers to any integrated circuit, accelerator card, or compute module optimized for a defined computational workload and having characterizable resource attributes including on-chip memory capacity, off-chip memory capacity and bandwidth, arithmetic throughput, and interconnect bandwidth. Processing elements of different types possess different resource profiles. Non-limiting examples of processing elements include graphics processing units (GPUs) such as the Nvidia H100, Nvidia A100, or AMD Instinct MI325X; neural processing units (NPUs) such as the TurboNext T1; language processing units (LPUs); field-programmable gate arrays (FPGAs); application-specific integrated circuits (ASICs); tensor processing units (TPUs); and general-purpose central processing units (CPUs). The claims are not limited to any particular type or commercial designation of processing element, and any accelerator or compute device having characterizable resource attributes falls within the scope of the term “processing element.”

As used herein, a “computational snippet” or “snippet” refers to a discrete, semantically defined portion of a Transformer block that is annotated with static resource-demand metadata describing at least compute density, memory footprint, and bandwidth demand. Non-limiting examples of computational snippets include a token-embedding snippet, a fully-connected layer snippet, a root-mean-square normalization snippet, a query-key dot-product snippet, a softmax snippet, and a key-query-value cross-product snippet. The decomposition of a Transformer block into computational snippets is agnostic to layer count, attention variant (including multi-head attention, multi-query attention, grouped-query attention, and multi-latent attention), numerical precision (including FP16 and INT8), and mixture-of-experts routing. The terms “computational part” and “computational snippet” are used interchangeably herein. The term “computational part” refers to any discrete portion of the model that is assigned as a unit to a processing element; a “computational snippet” is one species of computational part. Computational parts may be categorized as per-session-memory parts, which require memory that scales with the number of concurrent user sessions (such as attention snippets and their associated key-value caches), and shared-memory parts, which require memory that is common across all user sessions and does not scale with the number of concurrent user sessions (such as feed-forward-layer snippets that operate on model weights).

A scheduler circuit or executable control logic consults a resource characterization matrix and resource-demand metadata for each computational snippet and selects a placement plan by evaluating a multi-objective cost function spanning at least two of time-to-first-token latency, energy-per-token consumption, arithmetic-throughput utilization, fabric traffic volume, and incremental cloud-hosting cost, subject to one or more service-level latency targets. An optimization layer, interposed between a large-language-model serving software stack and a hardware abstraction layer, intercepts a computation graph generated by the serving software stack and emits one or more just-in-time kernels targeting the processing elements selected by the scheduler circuit or executable control logic. Throughout inference, the heterogeneous serving system maintains a single logical endpoint transparent to application code.

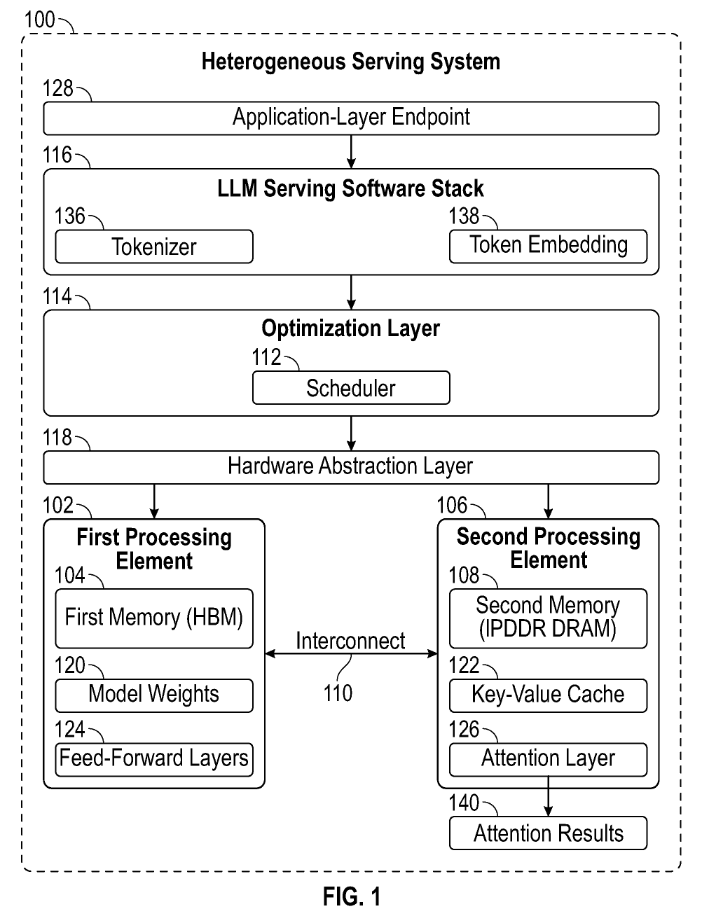

FIG. 1 is a block diagram of a heterogeneous serving system 100 for serving inference requests to a large language model, according to an embodiment. The heterogeneous serving system 100 includes an application-layer endpoint 128, a large-language-model serving software stack 116, an optimization layer 114 containing a scheduler circuit or executable control logic 112, a hardware abstraction layer 118, a first processing element 102 that is a graphics-processing unit, and a second processing element 106 that is a neural-processing unit. An interconnect interface 110 couples the first processing element 102 and the second processing element 106.

The application-layer endpoint 128 receives an inference request that includes a sequence of input tokens for a user session. The application-layer endpoint 128 exposes a representational state transfer or remote procedure call interface so that application code addresses a single logical endpoint irrespective of how the heterogeneous serving system 100 distributes computation across the first processing element 102 and the second processing element 106. After the heterogeneous serving system 100 generates one or more output tokens, the application-layer endpoint 128 returns a completed token sequence to the requesting application.

The large-language-model serving software stack 116 sits below the application-layer endpoint 128 and manages request scheduling, batching, tokenization, and context-window management. In some embodiments, the large-language-model serving software stack 116 comprises one or more of vLLM, TensorRT-LLM, or SGLang. As shown in FIG. 1, the large-language-model serving software stack 116 includes a tokenizer 136 that converts raw text of the inference request into the sequence of input tokens and a token embedding module 138 that maps each input token to a dense vector representation for processing by the Transformer layers. The large-language-model serving software stack 116 generates a computation graph representing the forward pass of the large language model for a given batch of inference requests.

The optimization layer 114 is interposed between the large-language-model serving software stack 116 and the hardware abstraction layer 118. The optimization layer 114 intercepts the computation graph generated by the large-language-model serving software stack 116 and decomposes the computation graph into a plurality of computational parts (i.e., computational snippets). Each computational part corresponds to a different functional block of the Transformer architecture. In some embodiments, the computational snippets include a token-embedding snippet, an attention snippet, a feed-forward network snippet, and a residual-norm snippet. The optimization layer 114 annotates each computational snippet with resource-demand metadata describing at least compute density and memory bandwidth requirements.

Prior to selecting a placement plan for a given inference request, the optimization layer 114 populates a resource characterization matrix by polling each processing element of a plurality of processing elements that include at least the first processing element 102 and the second processing element 106 for immutable resource descriptors comprising on-chip static-random-access-memory capacity, off-chip memory type and size, sustained memory bandwidth, arithmetic throughput expressed in operations per second, and interconnect bandwidth. In some embodiments, the resource characterization matrix is stored on a non-transitory computer-readable storage medium accessible to the scheduler circuit or executable control logic 112. The resource characterization matrix is populated once at system initialization and refreshed upon hardware topology changes.

The scheduler circuit or executable control logic 112 resides within the optimization layer 114. The scheduler circuit or executable control logic 112 is configured to obtain resource attributes for each processing element of the plurality of processing elements from the resource characterization matrix. The resource attributes comprise at least on-chip memory, off-chip memory bandwidth, and arithmetic throughput. The scheduler circuit or executable control logic 112 consults the resource-demand metadata annotated on each computational snippet and the resource attributes of each processing element, and selects a placement plan that assigns the feed-forward layers 124 of the model to the first processing element 102 and assigns the attention layer 126 of the model to the second processing element 106. The scheduler circuit or executable control logic 112 is further configured to coordinate execution of the assigned computational parts so that, in response to an inference request, the heterogeneous serving system 100 produces one or more output tokens.

In some embodiments, selecting the placement plan comprises evaluating a multi-objective cost function that minimizes at least two objectives selected from the group consisting of time-to-first-token latency, energy-per-token consumption, arithmetic-throughput utilization, fabric traffic volume, and incremental cloud-hosting cost, subject to one or more service-level latency targets. The scheduler circuit or executable control logic 112 evaluates candidate placement plans against the multi-objective cost function and selects the placement plan that satisfies the service-level latency targets while minimizing the selected objectives.

After the scheduler circuit or executable control logic 112 selects the placement plan, the optimization layer 114 emits one or more just-in-time kernels that target the first processing element 102 and the second processing element 106 according to the placement plan. The just-in-time kernels pass through the hardware abstraction layer 118, which translates the kernels into device-specific instructions for the underlying processing elements. In some embodiments, the hardware abstraction layer 118 comprises one or more of Compute Unified Device Architecture (CUDA) or Radeon Open Compute (ROCm).

The first processing element 102 is a graphics-processing unit and includes a first memory 104 adapted to store model weights 120 and to execute the feed-forward layers 124 of the model. The first memory 104 comprises high-bandwidth memory (HBM). The first processing element 102 provides high arithmetic throughput suited to the compute-bound matrix multiplications of the feed-forward layers 124, while the first memory 104 provides high sustained bandwidth to keep the arithmetic units of the first processing element 102 supplied with the model weights 120 and intermediate activations. During inference, the first processing element 102 applies the stored model weights 120 to activations derived from the input tokens of the inference request to execute the feed-forward layers 124.

The second processing element 106 is a neural-processing unit and includes a second memory 108, distinct from the first memory 104, adapted to store a session-specific key-value cache 122 (also referred to herein as session-specific state) and to execute the attention layer 126 of the model by referencing the key-value cache 122. The second memory 108 comprises off-chip dynamic-random-access memory coupled to the second processing element 106. In some embodiments, the second memory 108 comprises low-power double-data-rate (LPDDR) memory channels providing aggregate bandwidth to a commodity dynamic-random-access-memory pool at lower cost per byte and lower power consumption per byte than the first memory 104.

The heterogeneous serving system 100 allocates the key-value cache 122 for the user session in the second memory 108 while refraining from transferring or storing the key-value cache 122 in the first memory 104, which is the higher-bandwidth memory of the first processing element 102. The second memory 108 constitutes lower-cost off-chip memory relative to the first memory 104. The key-value cache 122 stores previously computed key vectors and value vectors for each attention layer 126 of the large language model, indexed by session identifier and attention layer 126, to avoid recomputation during autoregressive decoding. By maintaining the key-value cache 122 exclusively in the second memory 108, the heterogeneous serving system 100 frees high-bandwidth memory capacity on the first processing element 102 for the model weights 120 and intermediate activations of the feed-forward layers 124.

The second processing element 106 executes the attention layer 126 by accessing the key-value cache 122 locally in the second memory 108 and computing attention scores for the input tokens. In some embodiments, executing the attention layer 126 comprises retrieving key vectors and value vectors from the key-value cache 122, computing the attention scores by performing a dot product of query vectors derived from the input tokens and the retrieved key vectors, applying scaling and softmax normalization to the attention scores, and computing a weighted sum of the retrieved value vectors based on the normalized attention scores.

The interconnect interface 110 (also referred to herein as an interconnect) couples the first processing element 102 and the second processing element 106 and is dimensioned to transfer intermediate results, such as attention results 140, (also referred to herein as intermediate results) without transferring the key-value cache 122 to the first processing element 102. After the second processing element 106 completes execution of the attention layer 126, the heterogeneous serving system 100 transmits the attention results from the second processing element 106 to the first processing element 102 over the interconnect interface 110. The intermediate results comprise output vectors produced by the second computational part (i.e., the attention layer 126) and do not include any portion of the key-value cache 122. In some embodiments, the interconnect interface 110 comprises a Peripheral Component Interconnect Express (PCIe) link or an Ethernet connection.

The first processing element 102 receives the attention results over the interconnect interface 110 and completes execution of the feed-forward layers 124, including projection layers, non-linear activations, and residual connections. Through this coordinated execution of the assigned layers, the heterogeneous serving system 100 assembles one or more output tokens from the combined results of the computational parts, including the feed-forward layers 124 and the attention layer 126, completing the inference request while increasing inference throughput relative to a homogeneous graphics-processing-unit configuration at the same hardware cost.

In some embodiments, the heterogeneous serving system 100 generates the one or more output tokens by iteratively executing an autoregressive decoding loop. For each iteration, the heterogeneous serving system 100 produces a next output token from the combined results of the feed-forward layers 124 and the attention layer 126 and determines whether the next output token satisfies an end-of-sequence condition. Responsive to a determination that the end-of-sequence condition is not satisfied, the heterogeneous serving system 100 updates the key-value cache 122 in the second memory 108 with a key vector and a value vector computed from the next output token, appends the next output token to a context window, and repeats the execution of the feed-forward layers 124 on the first processing element 102 and the attention layer 126 on the second processing element 106 and the transmitting of the attention results over the interconnect interface 110 for the next output token. Responsive to a determination that the end-of-sequence condition is satisfied, the heterogeneous serving system 100 returns a completed token sequence via the application-layer endpoint 128.

In some embodiments, the scheduler circuit or executable control logic 112 implements a fallback policy. Responsive to a determination that arithmetic throughput of the first processing element 102 is saturated, the scheduler circuit or executable control logic 112 reassigns computational parts, including the feed-forward layers 124 and the attention layer 126, to the second processing element 106. Responsive to a determination that off-chip memory bandwidth of the second processing element 106 is depleted, the scheduler circuit or executable control logic 112 reassigns computational parts to a tensor-parallel configuration distributed across a set of processing elements of the first type.

Although FIG. 1 depicts one first processing element 102 and one second processing element 106, the heterogeneous serving system 100 may include a plurality of first processing elements 102 and a plurality of second processing elements 106. In some embodiments, the heterogeneous serving system 100 further includes a third processing element that is a graphics-processing unit of a different hardware generation or vendor than the first processing element 102, and the scheduler circuit or executable control logic 112 assigns the attention layer 126 to the second processing element 106 so as to relieve the first memory 104 and a corresponding memory of the third processing element from storing session-specific state (including key-value caches 122), thereby increasing utilization of arithmetic throughput of the first processing element 102 and the third processing element. Additional embodiments, including embodiments with GPU-only heterogeneous deployment, network-fabric disaggregation, and detailed snippet decomposition, are described in connection with subsequent figures.

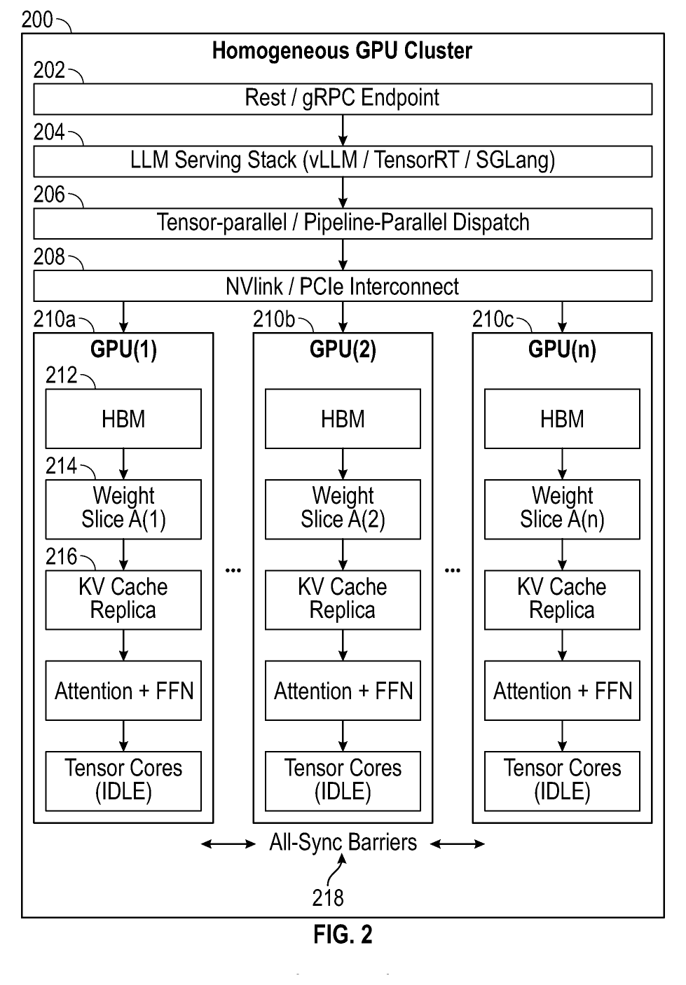

FIG. 2 is a block diagram of a homogeneous GPU cluster 200 representative of conventional large-language-model inference infrastructure. The homogeneous GPU cluster 200 includes a representational-state-transfer or remote-procedure-call endpoint 202, a large-language-model serving stack 204, a tensor-parallel or pipeline-parallel dispatch layer 206, a high-speed interconnect 208, and a plurality of graphics-processing units 210a, 210b through 210n that are identical in architecture, vendor, and hardware generation. Each of the graphics-processing units 210a, 210b through 210n includes a respective high-bandwidth memory 212, a weight slice 214, and a key-value cache replica 216. All-sync barriers 218 couple the plurality of graphics-processing units 210a, 210b through 210n to one another during each forward pass of the large language model.

In operation, the endpoint 202 receives an inference request containing a sequence of input tokens and forwards the inference request to the large-language-model serving stack 204. The large-language-model serving stack 204 may comprise vLLM, TensorRT-LLM, SGLang, or a comparable framework. The large-language-model serving stack 204 generates a computation graph for the forward pass and passes the computation graph to the tensor-parallel or pipeline-parallel dispatch layer 206. The tensor-parallel or pipeline-parallel dispatch layer 206 partitions the computation graph so that every layer of the Transformer is striped uniformly across the plurality of graphics-processing units 210a, 210b through 210n through the high-speed interconnect 208. The high-speed interconnect 208 may comprise NVLink, PCIe, or a comparable link.

Under tensor parallelism, a single weight matrix A is split column-wise into weight slices 214 designated A(1), A(2) through A(n), where n equals the number of graphics-processing units 210a, 210b through 210n. Each graphics-processing unit (210a, 210b through 210n) stores one weight slice 214 in the respective high-bandwidth memory 212 and computes a partial product X times A(i). An all-gather operation across the all-sync barriers 218 reassembles the partial products into a complete output vector Y. Because every graphics-processing unit (210a, 210b through 210n) must arrive at the all-sync barrier 218 before any graphics-processing unit (210a, 210b through 210n) may proceed, the slowest participant gates forward progress for the entire homogeneous GPU cluster 200.

Each graphics-processing unit (210a, 210b through 210n) also stores a complete key-value cache replica 216 for every active user session. During autoregressive decoding, each output token demands retrieval of key vectors and value vectors from the key-value cache replica 216 but requires comparatively few arithmetic operations. The workload therefore transitions from compute-bound to memory-bound, and the high-bandwidth memory 212 on each graphics-processing unit (210a, 210b through 210n) saturates with per-session state while tensor cores of the graphics-processing units 210a, 210b through 210n sit idle. Because high-bandwidth memory 212 is substantially more expensive per byte and more power-hungry per byte than commodity dynamic-random-access memory, scaling the homogeneous GPU cluster 200 to large numbers of concurrent sessions incurs a total cost of ownership that grows super-linearly with concurrency.

The all-sync barriers 218 compound the inefficiency. Each Transformer block is partitioned uniformly across the graphics-processing units 210a, 210b through 210n without regard to whether a given operation is compute-bound or memory-bound. Because the all-sync barriers 218 require every graphics-processing unit (210a, 210b through 210n) to synchronize at each layer boundary, any skew in clock speed, link health, or memory latency among the plurality of graphics-processing units 210a, 210b through 210n inflates end-to-end latency for the entire homogeneous GPU cluster 200. Tensor parallelism improves arithmetic utilization only when every graphics-processing unit (210a, 210b through 210n) shares an identical instruction mix, memory capacity, and interconnect width, and the approach degrades as soon as the homogeneous GPU cluster 200 mixes vendors, hardware generations, or memory configurations.

The homogeneous GPU cluster 200 therefore presents three compounding bottlenecks. First, the key-value cache replica 216 on every graphics-processing unit (210a, 210b through 210n) consumes high-bandwidth memory 212 that costs an order of magnitude more per byte and draws an order of magnitude more power per byte than low-power double-data-rate (LPDDR) dynamic-random-access memory, yet the key-value cache replica 216 requires only bandwidth, not arithmetic throughput, during autoregressive decoding. Second, because each of the graphics-processing units 210a, 210b through 210n executes both attention and feed-forward computations, the arithmetic throughput of the tensor cores on each graphics-processing unit (210a, 210b through 210n) is largely wasted during the memory-bound attention phase of every output token. Third, the homogeneous GPU cluster 200 cannot accommodate processing elements that differ in architecture, vendor, generation, or memory type, precluding the use of special-purpose accelerators whose memory characteristics better match the bandwidth-dominated profile of the attention workload. Accordingly, the heterogeneous serving system 100 addresses each of the three bottlenecks by allocating the key-value cache 122 in off-chip dynamic-random-access memory on the second processing element 106 while assigning the compute-bound feed-forward layers 124 to the first processing element 102, thereby freeing the first memory 104 for model weights 120 and restoring arithmetic-throughput utilization of the first processing element 102.

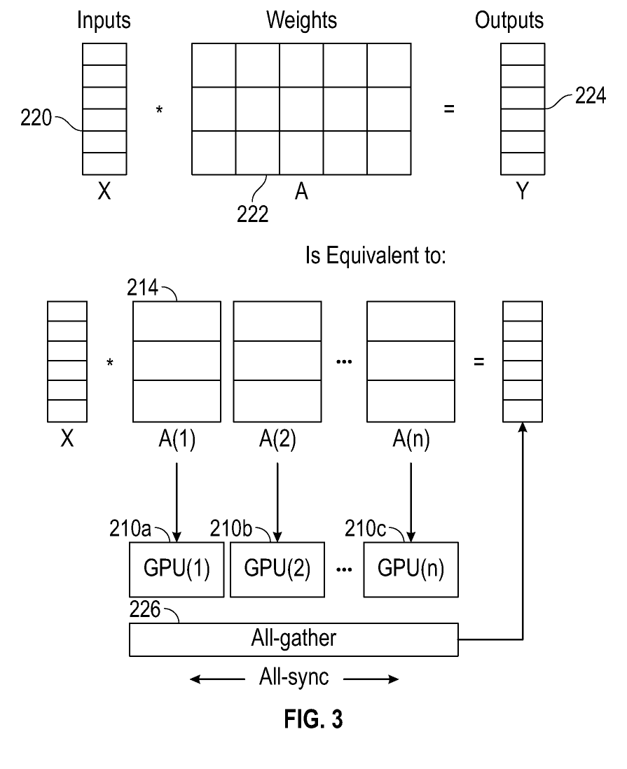

FIGS. 2 and 3 are presented as prior art to illustrate the baseline architecture that the heterogeneous serving system 100 is designed to overcome. Conventional large-language-model inference deploys tensor parallelism across a homogeneous GPU cluster 200 in which every graphics-processing unit (210a, 210b through 210n) is identical in architecture, memory capacity, interconnect width, and arithmetic throughput. FIG. 3 illustrates a tensor-parallel decomposition of a weight matrix 222 across a plurality of such graphics-processing units 210a, 210b through 210n to show why this uniformity constraint becomes a performance and cost bottleneck when hardware diversity is introduced.

In the unsplit case shown in the upper portion of FIG. 3, the computation is expressed as the product X times A equals Y, where X is an input activation vector 220 representing activations derived from a batch of input tokens at a given layer of the large language model, A is a weight matrix 222 representing model weights for a single fully-connected or feed-forward layer, and Y is an output vector 224 representing the resulting activations that are passed to the next layer. In this unsplit case, the weight matrix 222 resides entirely within the high-bandwidth memory 212 of a single graphics-processing unit (210a, 210b through 210n).

In the lower portion of FIG. 3, tensor parallelism splits the weight matrix 222 column-wise into n weight slices 214, designated A(1), A(2) through A(n), where n equals the number of graphics-processing units 210a, 210b through 210n in the homogeneous GPU cluster 200. Each graphics-processing unit (210a, 210b through 210n) stores exactly one weight slice 214 in the respective high-bandwidth memory 212 and computes a partial product X times A(i). The partial products are incomplete representations of the output vector 224 because each partial product reflects only the contribution from one weight slice 214.

After all of the graphics-processing units 210a, 210b through 210n complete the respective partial products, an all-gather operation 226 collects the partial products from every graphics-processing unit (210a, 210b through 210n) across the all-sync barriers 218 and reassembles the partial products into the complete output vector 224. The all-gather operation 226 requires each graphics-processing unit (210a, 210b through 210n) to transmit the respective partial product to every other graphics-processing unit (210a, 210b through 210n) through the high-speed interconnect 208 of FIG. 2, and none of the graphics-processing units 210a, 210b through 210n may proceed to the next layer until every graphics-processing unit (210a, 210b through 210n) has contributed the respective partial product. The all-sync barriers 218 therefore serialize forward progress to the speed of the slowest graphics-processing unit (210a, 210b through 210n), and any heterogeneity in clock frequency, memory bandwidth, or interconnect width among the plurality of graphics-processing units 210a, 210b through 210n causes every other graphics-processing unit (210a, 210b through 210n) to stall.

The tensor-parallel decomposition of FIG. 3 assumes that every graphics-processing unit (210a, 210b through 210n) is identical in architecture, memory capacity, and arithmetic throughput. When a cluster mixes graphics-processing units 210a, 210b through 210n of different vendors, hardware generations, or memory configurations, the weight slices 214 cannot be sized equally, the all-gather operation 226 becomes unbalanced, and the faster graphics-processing units 210a, 210b through 210n idle while waiting for slower participants at each all-sync barrier 218. Furthermore, under tensor parallelism each graphics-processing unit (210a, 210b through 210n) must store both a replica of the session-specific key-value cache and a weight slice in the same high-bandwidth memory, which forces the expensive high-bandwidth memory to absorb memory-bound attention traffic that could otherwise be served by lower-cost dynamic-random-access memory.

By contrast, the heterogeneous serving system 100 eliminates both the homogeneity constraint and the co-location of model weights and key-value caches. Rather than dividing a single weight matrix across identical processing units and synchronizing those processing units at every layer, the scheduler circuit or executable control logic 112 decomposes the computation graph into functionally distinct computational snippets and assigns each computational snippet to a processing element whose resource profile matches the resource demands of that computational snippet. Feed-forward layers 124, which are compute-bound, execute on the first processing element 102, which is a graphics-processing unit having high arithmetic throughput, while the attention layer 126 and its associated key-value cache 122, which are memory-bandwidth-bound, migrate to the second processing element 106, which is a neural-processing unit having large, lower-cost off-chip dynamic-random-access memory. Because the heterogeneous serving system 100 transfers compact attention results over the interconnect interface 110 rather than replicating weight slices or key-value caches across identical accelerators, the all-sync barriers 218 of the prior-art tensor-parallel configuration are eliminated, and processing elements of different architectures, vendors, and hardware generations contribute to a single inference request without stalling one another.

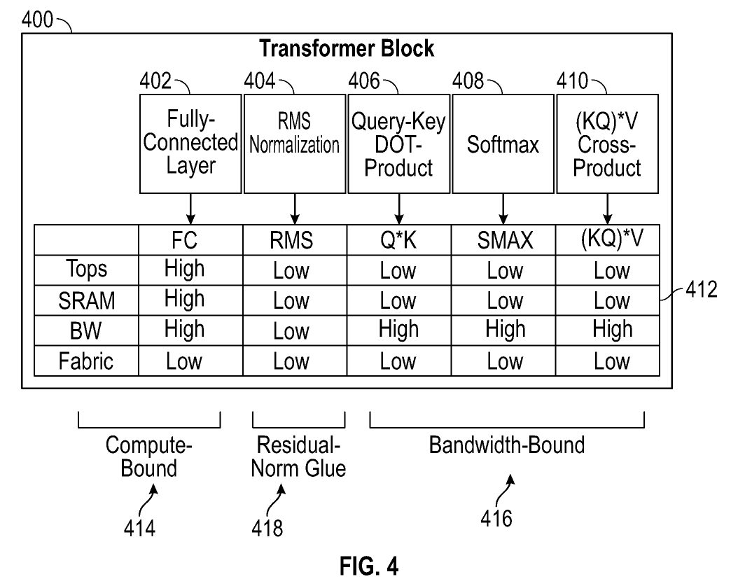

FIG. 4 is a block diagram illustrating a snippet decomposition of a Transformer block 400 into a plurality of computational snippets, each annotated with resource-demand metadata 412, according to an embodiment. Rather than assigning distinct layers to distinct devices as in pipeline parallelism, or splitting tensors homogeneously across identical devices as in the tensor-parallel configuration of FIGS. 2 and 3, the snippet decomposition decomposes the Transformer block 400 into semantic building blocks, each of which performs a unique function that can be characterized based on its requirements around compute, memory, and communication. The snippet decomposition adds another dimension for parallelism that is orthogonal to the existing scale-out axes of pipeline parallelism, tensor parallelism, data parallelism, and context parallelism, and is the mechanism by which the scheduler circuit or executable control logic 112 treats the large language model as a bag of heterogeneous tasks rather than a monolithic layer graph. In some embodiments, executing the assigned computational parts comprises distributing the computational parts across one or more of: a pipeline-parallel configuration in which successive Transformer blocks are assigned to successive processing elements; a data-parallel configuration in which different request batches are assigned to different processing elements or groups of processing elements; or a context-parallel configuration in which context partitions are assigned to different processing elements. The heterogeneous serving system 100 is capable of operating in each of these configurations in combination with the snippet decomposition described herein.

The Transformer block 400 is decomposed into five computational snippets: a fully-connected layer snippet 402, a root-mean-square normalization snippet 404, a query-key dot-product snippet 406, a softmax snippet 408, and a key-query-value cross-product snippet 410. The fully-connected layer snippet 402 corresponds to the feed-forward network of the Transformer architecture and performs dense matrix multiplications that transform activations between hidden dimensions. The root-mean-square normalization snippet 404 corresponds to the residual-normalization operations that stabilize activations between sub-layers of the Transformer block 400. The query-key dot-product snippet 406 computes attention scores by performing a dot product of query vectors derived from the input tokens and key vectors retrieved from the key-value cache 122. The softmax snippet 408 applies scaling and softmax normalization to the attention scores produced by the query-key dot-product snippet 406. The key-query-value cross-product snippet 410 computes a weighted sum of value vectors retrieved from the key-value cache 122, weighted by the normalized attention scores produced by the softmax snippet 408, to generate the attention output. The query-key dot-product snippet 406, the softmax snippet 408, and the key-query-value cross-product snippet 410 are collectively referred to herein as atomic snippets of the attention layer.

Each computational snippet is independently annotated with resource-demand metadata 412 that describes the resource profile of that computational snippet along at least four dimensions: tera-operations-per-second demand, on-chip static-random-access-memory footprint, off-chip memory bandwidth, and expected fabric traffic. As illustrated in the resource-demand metadata 412, the fully-connected layer snippet 402 exhibits high tera-operations-per-second demand, high on-chip static-random-access-memory footprint, and high off-chip memory bandwidth, but low fabric traffic. By contrast, the query-key dot-product snippet 406, the softmax snippet 408, and the key-query-value cross-product snippet 410 each exhibit low tera-operations-per-second demand and low on-chip static-random-access-memory footprint, but high off-chip memory bandwidth and low fabric traffic. The root-mean-square normalization snippet 404 exhibits low values across all four dimensions.

The resource-demand metadata 412 partitions the five computational snippets into three functional categories. The fully-connected layer snippet 402 falls into a compute-bound category 414, meaning that execution speed of the fully-connected layer snippet 402 is limited primarily by arithmetic throughput rather than by memory bandwidth. The query-key dot-product snippet 406, the softmax snippet 408, and the key-query-value cross-product snippet 410 collectively fall into a bandwidth-bound category 416, meaning that execution speed of those three snippets is limited primarily by the rate at which key vectors, value vectors, and intermediate attention scores can be read from and written to off-chip memory. The root-mean-square normalization snippet 404 falls into a residual-norm glue category 418, meaning that the root-mean-square normalization snippet 404 is lightweight in both compute and bandwidth and serves primarily as connective logic between the compute-bound and bandwidth-bound stages of the Transformer block 400.

The resource-demand metadata 412 is the information that the scheduler circuit or executable control logic 112 consults when selecting a placement plan. The mapping and scheduling of this placement occurs at runtime using just-in-time compilation against the known processing elements of the heterogeneous serving system 100. Because the fully-connected layer snippet 402 is compute-bound 414, the scheduler circuit or executable control logic 112 assigns the fully-connected layer snippet 402 to the first processing element 102, which is a graphics-processing unit having high arithmetic throughput from tensor cores that would otherwise remain under-utilized during memory-bound attention operations as shown in FIGS. 2 and 3. Because the query-key dot-product snippet 406, the softmax snippet 408, and the key-query-value cross-product snippet 410 are bandwidth-bound 416, the scheduler circuit or executable control logic 112 assigns those three snippets to the second processing element 106, which is a neural-processing unit having large, low-cost off-chip dynamic-random-access memory capable of sustaining the memory bandwidth those snippets require. Because the root-mean-square normalization snippet 404 is lightweight glue 418, the scheduler circuit or executable control logic 112 may assign the root-mean-square normalization snippet 404 to either the first processing element 102 or the second processing element 106, depending on which assignment minimizes transfer latency for the activations passed between the compute-bound and bandwidth-bound stages. In this manner, different processing elements need not be equally adept at running each type of snippet, and the snippet decomposition exploits this snippet affinity to match each computational snippet to the processing element best suited to its resource-demand profile.

The resource-demand metadata 412 is static for a given model architecture and does not change between inference requests. In some embodiments, the resource-demand metadata 412 is declared once per model when snippet boundaries are registered with the optimization layer 114. The static nature of the resource-demand metadata 412 means that the scheduler circuit or executable control logic 112 can precompute placement plans at system initialization and update those placement plans only when the hardware topology of the plurality of processing elements changes, without requiring re-training, re-quantization, or low-rank adaptation of the large language model. The snippet decomposition is agnostic to attention variant, precision format, layer count, and mixture-of-experts routing, and applies without modification to models employing multi-head attention, multi-query attention, grouped-query attention, and multi-latent attention architectures, at precisions including FP16 and INT8.

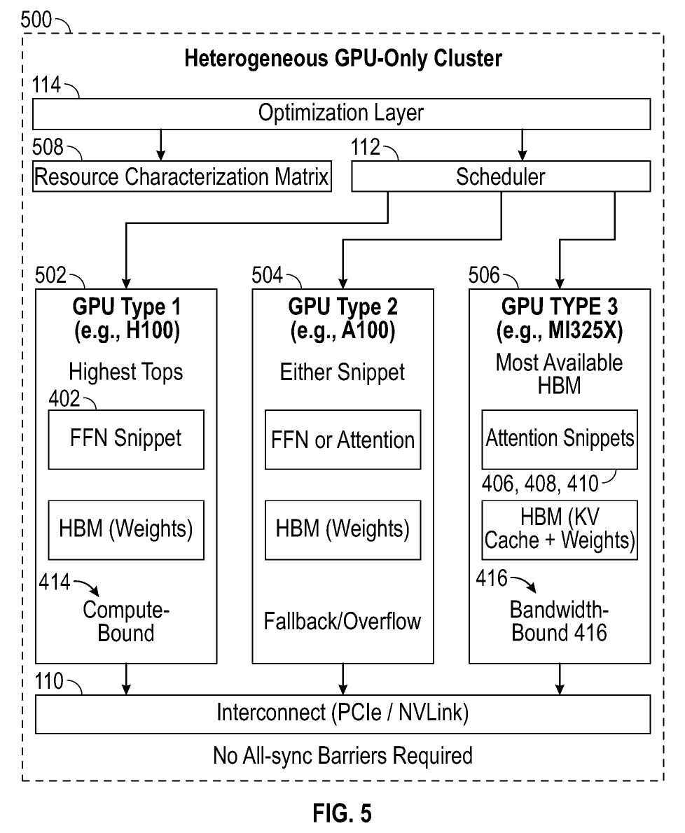

FIG. 5 is a system architecture diagram illustrating a heterogeneous GPU-only cluster 500 in which the optimization layer 114 dispatches computational snippets across a plurality of graphics-processing units that differ in at least one of vendor, hardware generation, or memory capacity, without requiring any neural-processing unit, according to an embodiment. The heterogeneous GPU-only cluster 500 represents a software-only deployment of the heterogeneous placement technique in which the optimization layer 114 improves utilization of existing graphics-processing-unit infrastructure by matching each computational snippet to the graphics-processing unit whose resource profile best satisfies the resource-demand metadata 412 for that computational snippet. Because no neural-processing unit is required, the embodiment of FIG. 5 illustrates the broadest scope of the heterogeneous placement technique and can be deployed on any cluster that mixes graphics-processing units of different types while maintaining a single logical endpoint transparent to application code.

The optimization layer 114 populates a resource characterization matrix 508 by polling each graphics-processing unit in the heterogeneous GPU-only cluster 500 for immutable resource descriptors comprising on-chip static-random-access-memory capacity, off-chip memory type and size, sustained memory bandwidth, arithmetic throughput expressed in tera-operations per second, and interconnect bandwidth. The resource characterization matrix 508 is populated once at system initialization and refreshed upon hardware topology changes. The scheduler circuit or executable control logic 112, residing within the optimization layer 114, consults the resource characterization matrix 508 and the resource-demand metadata 412 of each computational snippet to select a placement plan that assigns each computational snippet to a graphics-processing unit matched to the resource profile of that computational snippet. In some embodiments, the scheduler circuit or executable control logic 112 selects the placement plan by evaluating a multi-objective cost function (see FIG. 1), the multi-objective cost function minimizing at least two objectives selected from the group consisting of time-to-first-token latency, energy-per-token consumption, arithmetic-throughput utilization, fabric traffic volume, and incremental cloud-hosting cost, subject to one or more service-level latency targets. After the scheduler circuit or executable control logic 112 selects the placement plan, the optimization layer 114 emits one or more just-in-time kernels targeting the graphics-processing units selected by the placement plan, and the just-in-time kernels pass through the hardware abstraction layer 118 for translation into device-specific instructions. Because the optimization layer 114 continuously re-partitions the computation graph as load conditions change, the scheduler circuit or executable control logic 112 may reassign computational snippets among the graphics-processing units 502, 504, and 506 at runtime without interrupting in-flight inference requests.

In the embodiment of FIG. 5, the heterogeneous GPU-only cluster 500 includes a first graphics-processing unit 502 of a first type (e.g., H100), a second graphics-processing unit 504 of a second type (e.g., A100), and a third graphics-processing unit 506 of a third type (e.g., MI325X). The first graphics-processing unit 502 and the third graphics-processing unit 506 differ in at least one of hardware vendor, hardware generation, and memory capacity, such that the heterogeneous GPU-only cluster 500 mixes processing elements that would be incompatible under the tensor-parallel configuration of FIGS. 2 and 3. The first graphics-processing unit 502 provides the highest arithmetic throughput among the three types and is therefore assigned the fully-connected layer snippet 402, which is compute-bound 414 (see FIG. 4). The third graphics-processing unit 506 provides the most available high-bandwidth memory capacity among the three types and is therefore assigned the attention snippets 406, 408, and 410, which are bandwidth-bound 416 (see FIG. 4). The high-bandwidth memory of the third graphics-processing unit 506 stores both model weights and the session-specific key-value cache for the attention snippets. The second graphics-processing unit 504 is available for either the fully-connected layer snippet 402 or the attention snippets 406, 408, and 410, and the scheduler circuit or executable control logic 112 assigns the second graphics-processing unit 504 to whichever snippet category has the greater resource demand at a given time, providing a fallback and overflow capacity.

The graphics-processing units 502, 504, and 506 are coupled by an interconnect interface 110, which in some embodiments comprises a Peripheral Component Interconnect Express link, an NVLink connection, or an Ethernet connection. Because the scheduler circuit or executable control logic 112 assigns each computational snippet to a specific graphics-processing unit based on resource-demand metadata 412 rather than striping every snippet across every graphics-processing unit as in the tensor-parallel configuration of FIGS. 2 and 3, the heterogeneous GPU-only cluster 500 does not require all-sync barriers between the graphics-processing units 502, 504, and 506. The first graphics-processing unit 502 executes the compute-bound fully-connected layer snippet 402 and transmits compact attention-input activations to the third graphics-processing unit 506 over the interconnect interface 110. The third graphics-processing unit 506 executes the bandwidth-bound attention snippets 406, 408, and 410 and returns compact attention results over the interconnect interface 110. At no point does the key-value cache traverse the interconnect interface 110.

The software-only deployment of FIG. 5 reduces cloud-instance cost by improving utilization of the arithmetic throughput of each graphics-processing unit. In the prior-art tensor-parallel configuration of FIGS. 2 and 3, every graphics-processing unit must be identical, and the slowest graphics-processing unit gates forward progress at every all-sync barrier 218. In the heterogeneous GPU-only cluster 500 of FIG. 5, earlier-generation graphics-processing units such as the second graphics-processing unit 504 and the third graphics-processing unit 506 continue to contribute useful throughput because the scheduler circuit or executable control logic 112 assigns each graphics-processing unit the snippet category that matches its resource strengths. Once memory-bound attention traffic is directed to the graphics-processing unit with the most available high-bandwidth memory, the remaining graphics-processing units return to near-peak compute throughput without any incremental high-bandwidth-memory investment. In some embodiments, the software-only deployment of the optimization layer 114 reduces cloud-instance cost by approximately two times relative to a homogeneous graphics-processing-unit cluster sized for the same service-level agreement. The heterogeneous GPU-only cluster 500 therefore extends the productive life of sunk graphics-processing-unit capital while meeting service-level latency targets.

In some embodiments, the scheduler circuit or executable control logic 112 implements a fallback policy within the heterogeneous GPU-only cluster 500. Responsive to a determination that the high-bandwidth memory bandwidth of the third graphics-processing unit 506 is depleted, the scheduler circuit or executable control logic 112 reverts to a tensor-parallel configuration distributed across all available graphics-processing units 502, 504, and 506. In an alternative embodiment, the heterogeneous serving system 100 augments the heterogeneous GPU-only cluster 500 with one or more neural-processing units, each having large, low-cost off-chip dynamic-random-access memory, to which the attention snippets 406, 408, and 410 and the session-specific key-value cache migrate, thereby freeing the high-bandwidth memory of every graphics-processing unit for model weights and compute-bound activations.

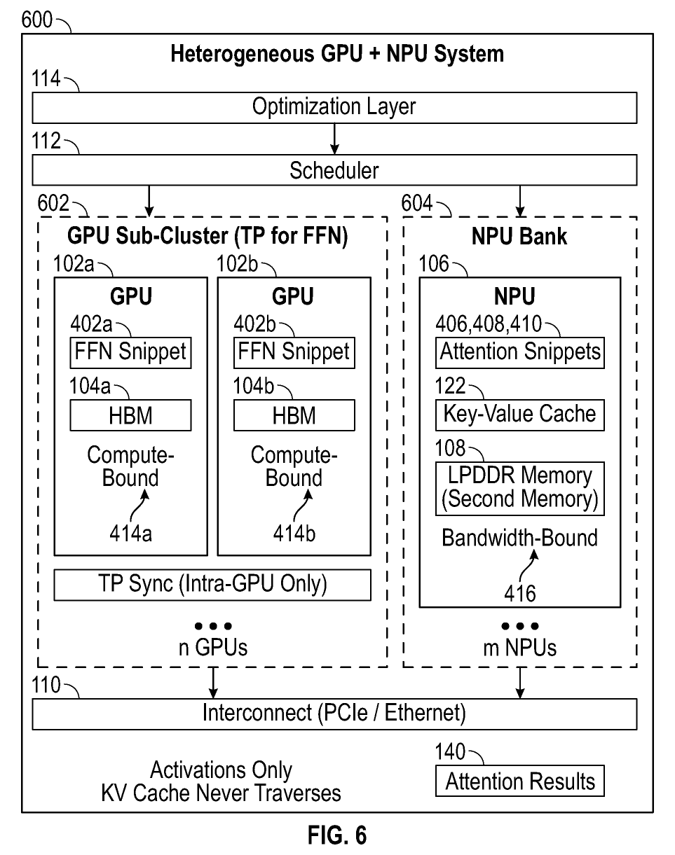

FIG. 6 is a system architecture diagram illustrating a heterogeneous GPU and NPU system 600 in which the optimization layer 114 augments the GPU-only deployment of FIG. 5 with one or more neural-processing units, according to an embodiment. In the heterogeneous GPU and NPU system 600, a GPU sub-cluster 602 retains tensor parallelism for the compute-bound fully-connected layer snippet and is shown containing a first graphics-processing unit 102a and a second graphics-processing unit 102b as representative instances of n graphics-processing units. A separate NPU bank 604 stores the session-specific key-value cache 122 and executes the bandwidth-bound attention snippets 406, 408, and 410 as representative instances of m neural-processing units. The heterogeneous GPU and NPU system 600 corresponds to the reference embodiment of the heterogeneous serving system 100, in which the first processing element 102 is a graphics-processing unit and the second processing element 106 is a neural-processing unit.

The GPU sub-cluster 602 includes a plurality of graphics-processing units, shown in FIG. 6 as a first graphics-processing unit 102a and a second graphics-processing unit 102b. Each graphics-processing unit includes a respective first memory, shown as a first high-bandwidth memory 104a in the first graphics-processing unit 102a and a second high-bandwidth memory 104b in the second graphics-processing unit 102b, adapted to store model weights and to execute a respective instance of the fully-connected layer snippet, shown as a first feed-forward-network snippet 402a in the first graphics-processing unit 102a and a second feed-forward-network snippet 402b in the second graphics-processing unit 102b. Each feed-forward-network snippet instance is compute-bound, as indicated by a first compute-bound annotation 414a associated with the first graphics-processing unit 102a and a second compute-bound annotation 414b associated with the second graphics-processing unit 102b. Within the GPU sub-cluster 602, the graphics-processing units 102a, 102b operate in a tensor-parallel configuration in which each graphics-processing unit stores a respective weight slice and computes a respective partial product. A tensor-parallel synchronization operation confined to the GPU sub-cluster 602 collects partial products from every graphics-processing unit within the GPU sub-cluster 602 and reassembles the partial products into a complete output for the fully-connected layer snippet. Because the tensor-parallel synchronization is confined to the GPU sub-cluster 602 and does not extend across the interconnect interface 110 to the NPU bank 604, no all-sync barrier spans both processing element types, and the graphics-processing units 102a, 102b need not wait for the neural-processing unit 106 or vice versa.

The NPU bank 604 includes one or more neural-processing units 106, each including a second memory 108 that is distinct from the first memories 104a, 104b of the graphics-processing units 102a, 102b. The second memory 108 comprises a plurality of low-power double-data-rate memory channels providing aggregate bandwidth to a commodity dynamic-random-access-memory pool. In some embodiments, the second memory 108 comprises four 32-bit-wide LPDDR5 channels per chiplet, giving an aggregate bandwidth of one hundred gigabytes per second and up to thirty-two gigabytes per chiplet. In some embodiments, eight chiplets are disposed on a single full-length Peripheral Component Interconnect Express Generation 5 card, thereby exposing up to two hundred fifty-six gigabytes of session-resident memory at approximately one-tenth the cost and power density of a high-bandwidth-memory-only alternative. A cost per byte and a power consumption per byte of the second memory 108 are each lower than a corresponding cost per byte and power consumption per byte of the first memory 104. The heterogeneous GPU and NPU system 600 allocates the key-value cache 122 for each user session in the second memory 108 while refraining from transferring or storing the key-value cache 122 in the first memories 104a, 104b, thereby freeing high-bandwidth memory capacity on each graphics-processing unit 102a, 102b for model weights and compute-bound activations.

The neural-processing unit 106 executes the attention snippets 406, 408, and 410, which are bandwidth-bound 416 (see FIG. 4), by accessing the key-value cache 122 locally in the second memory 108. In some embodiments, executing the attention snippets comprises the operations, including retrieving key vectors and value vectors from the key-value cache 122, computing attention scores, and computing a weighted sum of the retrieved value vectors based on normalized attention scores. Because the key-value cache 122 resides locally in the second memory 108, the neural-processing unit 106 does not require high-bandwidth memory ingress to access session-specific state, eliminating the bandwidth bottleneck that limits multi-tenant concurrency in the prior-art configuration of FIGS. 2 and 3. In one example, the prior-art configuration requires approximately three terabytes per second of high-bandwidth-memory ingress to reload key-value caches for thousands of concurrent sessions, and the heterogeneous GPU and NPU system 600 eliminates that ingress entirely because the key-value cache 122 is accessed locally in the second memory 108.

The GPU sub-cluster 602 and the NPU bank 604 are coupled by the interconnect interface 110, which in some embodiments comprises a Peripheral Component Interconnect Express link or an Ethernet connection. The interconnect interface 110 is dimensioned to transfer intermediate results (i.e., attention results 140) without transferring the key-value cache 122 to the graphics-processing units 102a, 102b. During inference, each graphics-processing unit 102a, 102b in the GPU sub-cluster 602 transmits compact attention-input activations to the neural-processing unit 106 over the interconnect interface 110, and the neural-processing unit 106 returns compact attention results 140 over the interconnect interface 110 after executing the attention snippets 406, 408, and 410. The intermediate results comprise output vectors produced by the second computational part (i.e., the attention snippets 406, 408, and 410) and do not include any portion of the key-value cache 122. At no point does the key-value cache 122 traverse the interconnect interface 110, as indicated in FIG. 6 by the annotation that only activations traverse the interconnect and the key-value cache never traverses the interconnect.

In some embodiments, the heterogeneous serving system 100 further includes non-volatile storage selected from one or more solid-state drives, network-attached storage, or storage local to the second processing element 106. The non-volatile storage may stage model weights, checkpoint shards, session-specific state, or key-value-cache spill data for execution by the first processing element 102 or the second processing element 106.

The heterogeneous GPU and NPU system 600 provides a reduction in infrastructure capital expenditure and energy consumption relative to a homogeneous graphics-processing-unit cluster sized for the same service-level agreement. In some embodiments, the addition of the NPU bank 604 to the heterogeneous serving system 100 yields a three-to-seven-fold reduction in infrastructure capital expenditure and a greater-than-three-fold reduction in breaker-level energy versus an all-graphics-processing-unit cluster meeting the same service-level latency targets. Because the key-value cache 122 no longer occupies high-bandwidth memory on each graphics-processing unit 102a, 102b, the graphics-processing units in the GPU sub-cluster 602 return to near-peak arithmetic throughput, extending the productive life of earlier-generation graphics-processing units without any incremental high-bandwidth-memory investment.

In some embodiments, the scheduler circuit or executable control logic 112 implements the fallback policy within the heterogeneous GPU and NPU system 600. Responsive to a determination that arithmetic throughput of the graphics-processing units 102a, 102b in the GPU sub-cluster 602 is saturated, the scheduler circuit or executable control logic 112 spills new inference sessions entirely to the NPU bank 604, such that the neural-processing unit 106 executes both the feed-forward layers and the attention layer for those sessions. Responsive to a determination that off-chip memory bandwidth of the neural-processing unit 106 is depleted, the scheduler circuit or executable control logic 112 reassigns computational parts to a tensor-parallel configuration distributed across all available graphics-processing units 102a, 102b.

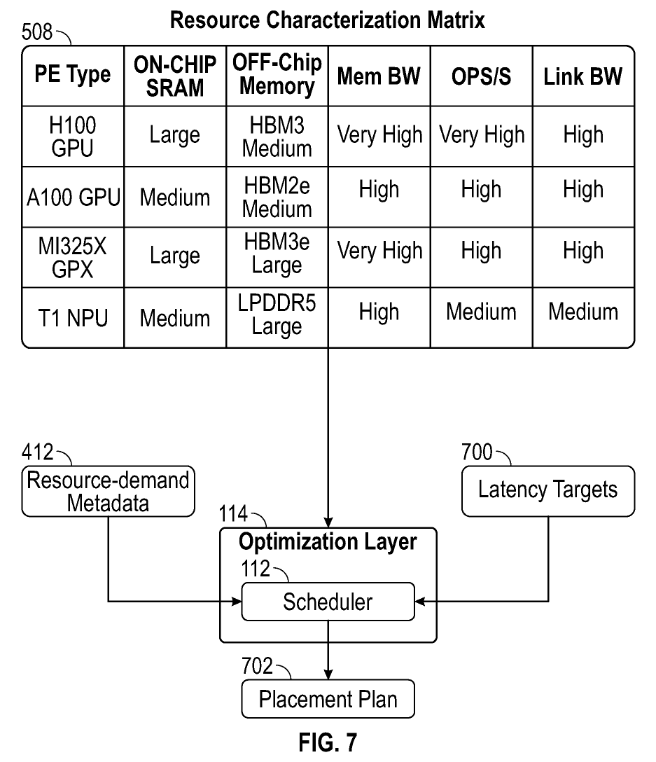

FIG. 7 is a diagram illustrating a resource characterization matrix 508 and a scheduler circuit or executable control logic 112 within the optimization layer 114, according to an embodiment. The resource characterization matrix 508 tabulates resource attributes for a representative mix of processing elements that include graphics-processing units and neural-processing units. Within the optimization layer 114, the scheduler circuit or executable control logic 112 consults the resource characterization matrix 508 and the resource-demand metadata 412 to select a placement plan 702 for each inference request, subject to one or more service-level latency targets 700.

The optimization layer 114 populates the resource characterization matrix 508 by polling each processing element of a plurality of processing elements for immutable resource descriptors comprising on-chip static-random-access-memory capacity, off-chip memory type and size, sustained memory bandwidth, arithmetic throughput expressed in tera-operations per second, and interconnect bandwidth. The resource characterization matrix 508 is stored on a non-transitory computer-readable storage medium accessible to the scheduler circuit or executable control logic 112 and is populated once at system initialization and refreshed upon hardware topology changes.

In the embodiment, the resource characterization matrix 508 includes entries for four representative processing element types. A first entry corresponds to an H100 graphics-processing unit having high-bandwidth memory of the HBM3 type, a second entry corresponds to an A100 graphics-processing unit having high-bandwidth memory of the HBM2e type, a third entry corresponds to an MI325X graphics-processing unit having high-bandwidth memory of the HBM3e type, and a fourth entry corresponds to a T1 neural-processing unit having off-chip memory of the LPDDR5 type. Each entry records the on-chip static-random-access-memory capacity, the off-chip memory capacity and type, the sustained memory bandwidth, the arithmetic throughput in tera-operations per second, and the interconnect bandwidth for the respective processing element. The resource characterization matrix 508 is not limited to the four processing element types shown and may include entries for any processing element available in the heterogeneous serving system 100, including central processing units.

The scheduler circuit or executable control logic 112 includes a multi-objective optimizer that, at admission time for each inference request, evaluates candidate placement plans against a multi-objective cost function. The multi-objective cost function minimizes at least two objectives selected from the group consisting of time-to-first-token latency, energy-per-token consumption, arithmetic-throughput utilization, fabric traffic volume, and incremental cloud-hosting cost. The multi-objective optimizer compares the resource-demand metadata 412 of each computational snippet against the resource attributes recorded in the resource characterization matrix 508 and generates a set of candidate placement plans, each candidate placement plan assigning each computational snippet to a respective processing element. The multi-objective optimizer then evaluates each candidate placement plan against the multi-objective cost function and selects the placement plan 702 that satisfies the service-level latency targets 700 while minimizing the selected objectives.

The service-level latency targets 700 define an envelope within which the selected placement plan 702 is configured to operate. In some embodiments, the service-level latency targets 700 comprise a maximum time-to-first-token latency of no more than six hundred milliseconds and a maximum inter-token latency of no more than twenty milliseconds. The multi-objective optimizer discards any candidate placement plan that violates the service-level latency targets 700 before evaluating the remaining candidate placement plans against the multi-objective cost function.

The selected placement plan 702 assigns the compute-bound fully-connected layer snippet 402 to a graphics-processing unit having the highest arithmetic throughput and assigns the bandwidth-bound attention snippets 406, 408, and 410 to a processing element having the largest off-chip memory capacity and highest sustained memory bandwidth (see FIGS. 5 and 6). In some embodiments, the scheduler circuit or executable control logic 112 implements the fallback policy when generating the placement plan 702. The placement plan 702 is then provided to the optimization layer 114, which emits one or more just-in-time kernels targeting the processing elements identified by the placement plan 702.

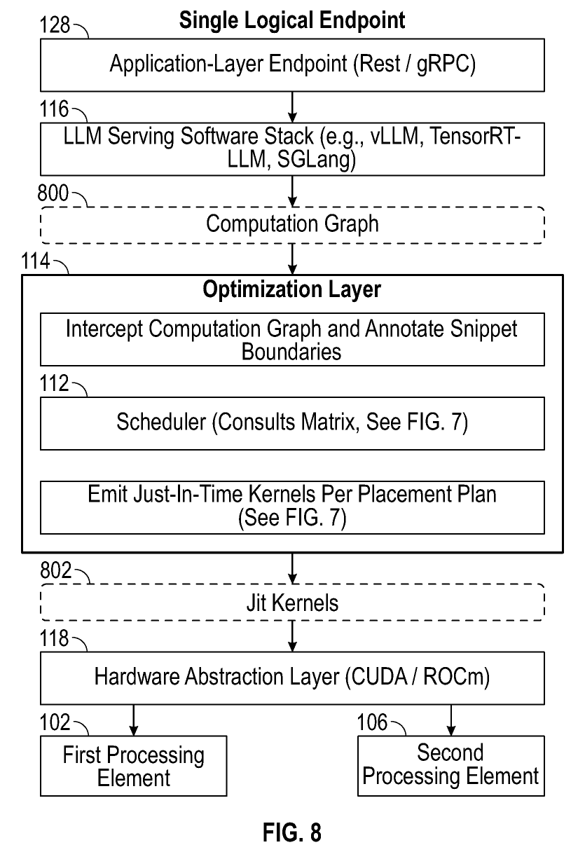

FIG. 8 is a system architecture diagram illustrating the position of the optimization layer 114 within the software stack of the heterogeneous serving system 100, according to an embodiment. The optimization layer 114 is interposed between the large-language-model serving software stack 116 and the hardware abstraction layer 118. The application-layer endpoint 128 sits above the large-language-model serving software stack 116 and exposes a single logical endpoint, such as a representational state transfer or remote procedure call interface, so that application code addresses one endpoint irrespective of how the heterogeneous serving system 100 distributes computation across the first processing element 102 and the second processing element 106.

The large-language-model serving software stack manages request scheduling, batching, tokenization, and context-window management for inference requests received via the application-layer endpoint 128. In some embodiments, the large-language-model serving software stack 116 comprises one or more of vLLM, TensorRT-LLM, or SGLang. The large-language-model serving software stack 116 generates a computation graph 800 representing the forward pass of the large language model for a given batch of inference requests. The computation graph 800 is passed downward to the optimization layer 114.

The optimization layer 114 intercepts the computation graph 800 generated by the large-language-model serving software stack 116 and decomposes the computation graph 800 into a plurality of computational snippets, each computational snippet corresponding to a different functional block of the Transformer architecture (see FIG. 4). The optimization layer 114 annotates each computational snippet with resource-demand metadata 412 describing at least compute density and memory bandwidth requirements. The scheduler circuit or executable control logic 112, residing within the optimization layer 114, consults the resource characterization matrix 508 and the resource-demand metadata 412 of each computational snippet to select a placement plan 702. After the scheduler circuit or executable control logic 112 selects the placement plan 702, the optimization layer 114 emits one or more just-in-time kernels 802 that target the first processing element 102 and the second processing element 106 according to the placement plan 702.

The just-in-time kernels 802 pass through the hardware abstraction layer 118, which translates the just-in-time kernels 802 into device-specific instructions for the underlying processing elements. In some embodiments, the hardware abstraction layer 118 comprises one or more of Compute Unified Device Architecture or Radeon Open Compute. Because the optimization layer 114 sits above the hardware abstraction layer 118, the just-in-time kernels 802 are expressed in a device-agnostic form and are translated into vendor-specific instructions at the hardware abstraction layer 118, enabling the heterogeneous serving system 100 to target processing elements from different vendors without modifying the optimization layer 114 or the large-language-model serving software stack 116.

Because the optimization layer 114 is interposed between the large-language-model serving software stack 116 and the hardware abstraction layer 118, existing application code that interfaces with the large-language-model serving software stack 116 remains oblivious to the heterogeneous placement of computational parts. Application code addresses the single logical endpoint exposed by the application-layer endpoint 128 irrespective of the placement plan, while the physical implementation of inference mutates across racks, vendors, and model revisions underneath. The optimization layer 114 continuously re-partitions the computation graph 800 across heterogeneous silicon as load conditions change, and no modification to the application code or the large-language-model serving software stack 116 is required to take advantage of additional or replacement processing elements.

In some embodiments, the optimization layer 114 is further configured to encapsulate the attention results produced by the second processing element 106 into network packets for transmission over a switching fabric that couples the first processing element 102 and the second processing element 106 across separate chassis or racks. In such embodiments, a host central-processing unit is excluded from the data path between the first processing element 102 and the second processing element 106 during inference. In one embodiment, excluding the host central-processing unit from the data path raises rack-level compute density by approximately twenty percent.

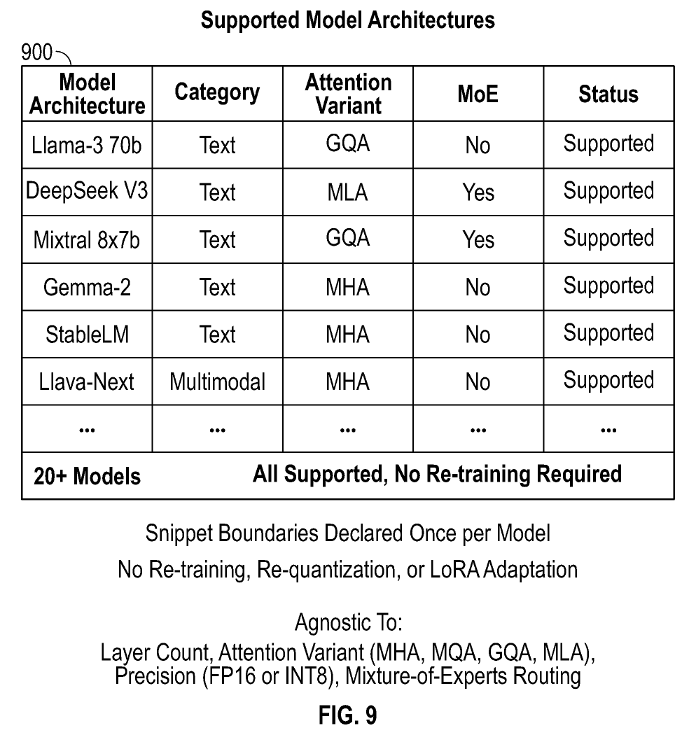

FIG. 9 is a table 900 listing representative model architectures that are supported by the snippet decomposition and the optimization layer 114 without modification to the model weights, according to an embodiment. FIG. 9 demonstrates that the semantic decomposition of each Transformer block into computational snippets is agnostic to the specific model architecture, and that the heterogeneous placement technique applies across a broad range of large language models.

The table 900 includes entries for representative model architectures including Llama-3 70B, DeepSeek V3, Mixtral 8x7B, Gemma-2, StableLM, and Llava-Next. The represented attention variants include multi-head attention, multi-query attention, grouped-query attention, and multi-latent attention, at precisions including FP16 and INT8. Models employing mixture-of-experts routing are supported alongside dense models because the snippet decomposition operates at the functional-block level of each Transformer block rather than at the level of expert selection or gating. Porting each model architecture to the heterogeneous placement technique requires that snippet boundaries be declared once per model when the model is registered with the optimization layer 114 (see FIG. 4). No re-training, re-quantization, or low-rank adaptation of the model weights is necessary.

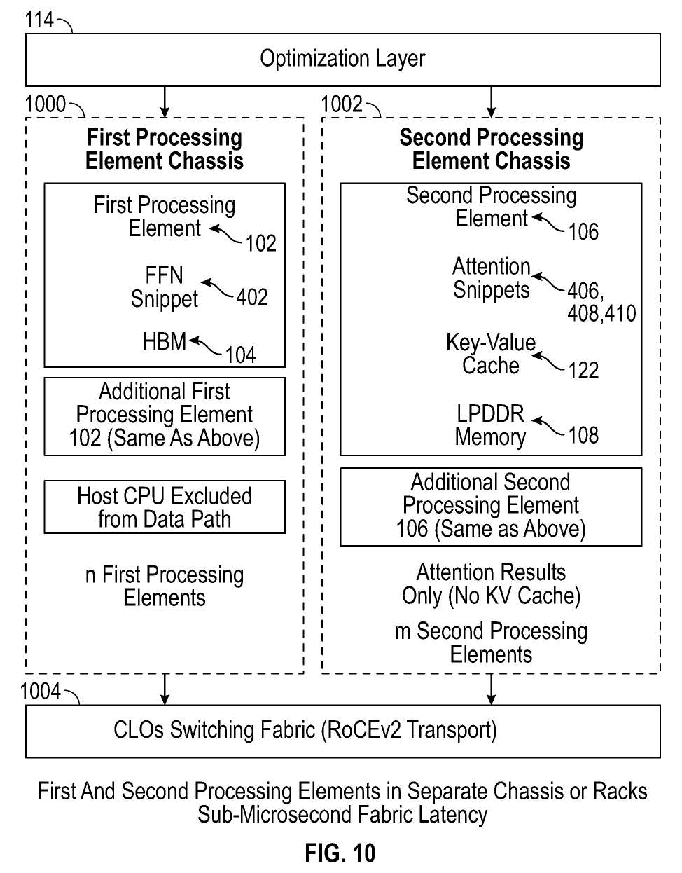

FIG. 10 is a system architecture diagram illustrating a network-fabric disaggregation embodiment of the heterogeneous serving system 100, according to an embodiment. In the embodiment of FIG. 10, the first processing elements 102 and the second processing elements 106 reside in separate chassis or racks coupled by a Clos switching fabric 1004, rather than sharing a single interconnect 110 within one chassis (see FIG. 6). The optimization layer 114 translates the computational snippets into network-routable snippet payloads that traverse the Clos switching fabric 1004 between a first-processing-element chassis 1000 and a second-processing-element chassis 1002.

The first-processing-element chassis 1000 houses n first processing elements 102, each including a first memory 104 comprising high-bandwidth memory adapted to store model weights and to execute the compute-bound fully-connected layer snippet 402. The first processing elements 102 within the first-processing-element chassis 1000 may operate in a tensor-parallel configuration for the fully-connected layer snippet 402 (see FIG. 6), or may individually execute the fully-connected layer snippet 402 (see FIG. 5). As indicated in FIG. 10, a host central-processing unit is excluded from the data path between the first processing elements 102 and the second processing elements 106 during inference. By removing the host central-processing unit from the data path, the first-processing-element chassis 1000 dedicates its bus and memory bandwidth to first-processing-element computation and fabric communication, thereby raising rack-level compute density by approximately twenty percent.

The second-processing-element chassis 1002 houses m second processing elements 106, each including a second memory 108 comprising low-power double-data-rate memory channels adapted to store the session-specific key-value cache 122 and to execute the bandwidth-bound attention snippets 406, 408, and 410. The key-value cache 122 resides exclusively in the second memory 108 of the second processing element 106 (see FIGS. 1 and 6), and does not traverse the Clos switching fabric 1004. As indicated in FIG. 10, only attention results are transmitted from the second-processing-element chassis 1002 to the first-processing-element chassis 1000 over the Clos switching fabric 1004, and no portion of the key-value cache 122 is included in the transmitted attention results.

The Clos switching fabric 1004 couples the first-processing-element chassis 1000 and the second-processing-element chassis 1002 across separate chassis or separate racks, as annotated in FIG. 10. The Clos switching fabric 1004 employs Remote Direct Memory Access (RDMA) over Converged Ethernet version 2 (RoCEv2) as the transport protocol. The optimization layer 114 encapsulates the attention results produced by the second processing elements 106 into network packets routed over the Clos switching fabric 1004, and the network packets re-join the first-processing-element-resident feed-forward activations in the first-processing-element chassis 1000. As indicated in FIG. 10, the Clos switching fabric 1004 provides sub-microsecond fabric latency between the first-processing-element chassis 1000 and the second-processing-element chassis 1002. Because the data crossing the Clos switching fabric 1004 is compact attention-input activations and compact attention results, the fabric bandwidth required is a small fraction of the bandwidth that would be required to transfer key-value caches between chassis, enabling the disaggregated topology to meet the same service-level latency targets 700 as the single-chassis embodiment of FIG. 6.

The network-fabric disaggregation of FIG. 10 enables the heterogeneous serving system 100 to scale beyond the confines of a single chassis or a single rack. Additional first-processing-element chassis 1000 and additional second-processing-element chassis 1002 may be added to the Clos switching fabric 1004 without modifying the optimization layer 114 or the large-language-model serving software stack 116. In some embodiments, the Clos switching fabric 1004 is implemented using Cisco Nexus inference line-cards, and the optimization layer 114 translates the attention snippets into RoCEv2 packets that traverse the Clos switching fabric 1004 before re-joining first-processing-element-resident feed-forward activations. Application code continues to address a single logical endpoint via the application-layer endpoint 128, irrespective of how many chassis or racks participate in inference.

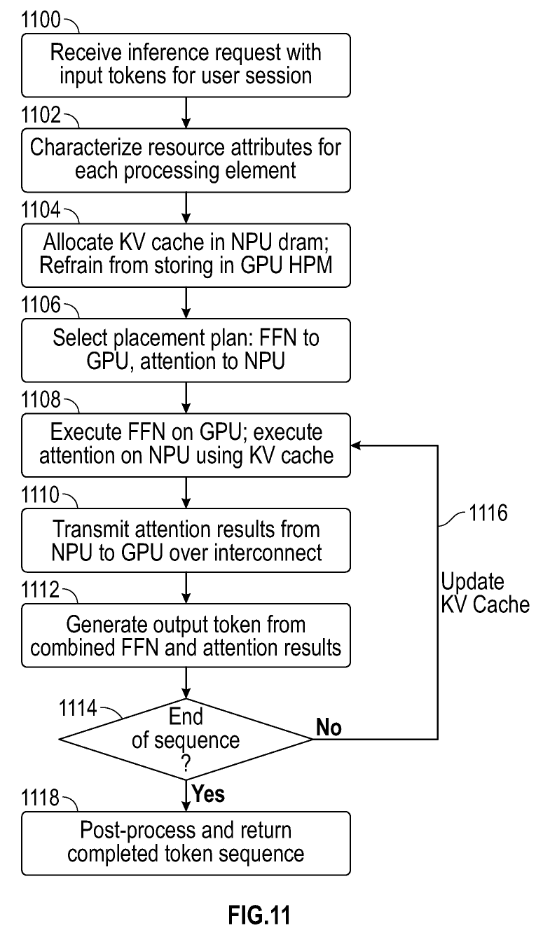

FIG. 11 is a flowchart illustrating one embodiment of a method of executing inference in the heterogeneous serving system 100 for a large language model.

At step 1100, the heterogeneous serving system 100 receives an inference request that includes a sequence of input tokens for a user session. The inference request is received via the application-layer endpoint 128, which exposes a representational state transfer or remote procedure call interface. The input tokens may comprise natural language, structured queries, or other formats suitable for Transformer processing.

At step 1102, the heterogeneous serving system 100 characterizes, for each of a plurality of processing elements that include at least one graphics-processing unit 102 and at least one neural-processing unit 106, respective resource attributes comprising on-chip memory, off-chip memory bandwidth, and arithmetic throughput. In some embodiments, the characterizing step is performed prior to receiving the inference request at step 1100 by populating the resource characterization matrix 508 (see FIG. 1). The resource characterization matrix 508 is populated once at system initialization and refreshed upon hardware topology changes, so that step 1102 may be performed once and reused for multiple inference requests.

At step 1104, the heterogeneous serving system 100 allocates, in the off-chip dynamic-random-access memory 108 coupled to the neural-processing unit 106, a key-value cache 122 for the user session while refraining from storing the key-value cache 122 in the first memory 104 of the graphics-processing unit 102. For new sessions, a key-value cache structure is allocated in the second memory 108, indexed by session identifier and attention layer for efficient access. For ongoing sessions, the stored key-value cache 122 is retrieved from the second memory 108 without moving the key-value cache 122 to the graphics-processing unit 102, thereby preserving high-bandwidth memory capacity for model weights and compute-bound activations.

At step 1106, the scheduler circuit or executable control logic 112 consults the resource attributes characterized at step 1102 and selects a placement plan 702 that assigns the feed-forward layers of the model to the graphics-processing unit 102 and assigns the attention layer of the model to the neural-processing unit 106. In some embodiments, step 1106 includes evaluating a multi-objective cost function (see FIG. 7).

At step 1108, the heterogeneous serving system 100 executes, according to the placement plan 702, the feed-forward layers on the graphics-processing unit 102 by applying stored model weights to activations derived from the input tokens, and the attention layer on the neural-processing unit 106 by accessing the key-value cache 122 and computing attention scores for the input tokens. In some embodiments, executing the attention layer comprises retrieving key vectors and value vectors from the key-value cache 122, computing the attention scores by performing a dot product of query vectors derived from the input tokens and the retrieved key vectors, applying scaling and softmax normalization to the attention scores, and computing a weighted sum of the retrieved value vectors based on the normalized attention scores. The attention computations are performed locally on the neural-processing unit 106, avoiding key-value cache transfers to the graphics-processing unit 102.

At step 1110, the heterogeneous serving system 100 transmits attention results from the neural-processing unit 106 to the graphics-processing unit 102 over the interconnect 110. The attention results comprise output vectors produced by the attention layer and do not include any portion of the key-value cache 122. The graphics-processing unit 102 receives the attention results and completes execution of the feed-forward layers, including projection layers, non-linear activations, and residual connections. In some embodiments, orchestration protocols using just-in-time compilation and load balancing manage the parallel execution across the graphics-processing unit 102 and the neural-processing unit 106, minimizing data transfer overhead via the interconnect 110.

At step 1112, the heterogeneous serving system 100 assembles one or more output tokens from the combined results of the computational parts, including the feed-forward layers and the attention layer, completing the inference request while increasing inference throughput relative to a homogeneous graphics-processing-unit configuration at the same hardware cost.

At step 1114, the heterogeneous serving system 100 determines whether a next output token produced at step 1112 satisfies an end-of-sequence condition. Responsive to a determination that the end-of-sequence condition is not satisfied, at step 1116 the heterogeneous serving system 100 updates the key-value cache 122 in the second memory 108 with a key vector and a value vector computed from the next output token, appends the next output token to a context window, and repeats the executing at step 1108 and the transmitting at step 1110 for the next output token in an autoregressive decoding loop.

Responsive to a determination at step 1114 that the end-of-sequence condition is satisfied, at step 1118 the heterogeneous serving system 100 post-processes the completed token sequence, which may involve detokenizing the output into natural language, applying formatting, or adding metadata. The final output is returned to the requesting application via the application-layer endpoint 128. In some embodiments, the heterogeneous serving system 100 performs optional housekeeping tasks after step 1118, such as retaining or evicting key-value cache entries in the second memory 108, logging session metrics, and scheduling memory compaction or load-balancing tasks.

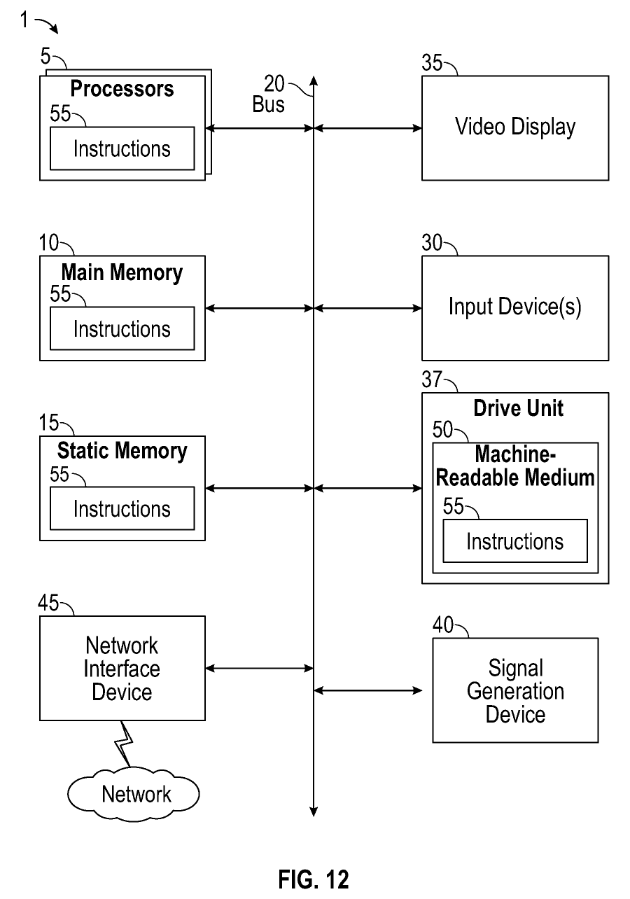

FIG. 12 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term "computer-readable medium" should be taken to include a single medium or multiple media (e.g., a centralized or distributed database and/or associated caches and servers) that store the one or more sets of instructions. The term "computer-readable medium" shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term "computer-readable medium" shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware. Where appropriate, the functions described herein can be performed in one or more of hardware, software, firmware, digital components, or analog components. For example, the systems and methods described herein can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

What is claimed is:

1. A method of executing inference in a heterogeneous serving system for a large language model, the method comprising:
receiving an inference request that includes a sequence of input tokens for a user session;
characterizing, for each of a plurality of processing elements that include at least a first processing element and a second processing element having a type or resource profile different from that of the first processing element, respective resource attributes comprising on‑chip memory, off‑chip memory bandwidth, and arithmetic throughput;
decomposing the model into a plurality of computational parts that differ in their memory and arithmetic demands;
selecting, by a scheduler that consults the resource attributes, a placement plan that assigns at least a first computational part to the first processing element and a second computational part to the second processing element;
executing the assigned computational parts on their respective processing elements according to the placement plan;
transmitting intermediate results between the first processing element and the second processing element via an interconnect interface coupling the first processing element and the second processing element; and
assembling one or more output tokens from combined results of the computational parts, completing the inference request while increasing inference throughput relative to a homogeneous graphics‑processing‑unit configuration at the same hardware cost.

2. The method of claim 1, wherein the first processing element is a graphics‑processing unit (GPU) and the second processing element is a neural‑processing unit (NPU), and wherein executing the second computational part on the second processing element comprises:
allocating, in off‑chip dynamic‑random‑access memory coupled to the second processing element, a key‑value cache for the user session; and retrieving, from the key‑value cache, key vectors and value vectors associated with the user session;
computing attention scores by performing a dot product of query vectors derived from the input tokens and the retrieved key vectors;
applying scaling and softmax normalization to the attention scores; and
computing a weighted sum of the retrieved value vectors based on the normalized attention scores.

3. The method of claim 1, further comprising: dividing the model into computational parts that include per‑session‑memory parts requiring memory that scales with a number of concurrent user sessions, and shared‑memory parts requiring memory that is common across all user sessions and does not scale with the number of concurrent user sessions; and allocating per‑session‑memory parts to the second processing element having lower‑cost off‑chip memory and allocating the shared‑memory parts to the first processing element having higher‑bandwidth memory.

4. The method of claim 1, wherein executing the first computational part comprises distributing the first computational part across a tensor‑parallel configuration of a plurality of processing elements of a same type as the first processing element.

5. The method of claim 1, further comprising:
intercepting, by an optimization layer interposed between a large‑language‑model serving software stack and a hardware abstraction layer, a computation graph generated by the serving software stack; and
emitting, by the optimization layer, one or more just‑in‑time kernels that target the first processing element and the second processing element according to the placement plan, wherein application code interfacing with the serving software stack addresses a single logical endpoint irrespective of the placement plan.

6. The method of claim 1, wherein executing the assigned computational parts comprises distributing the computational parts across a pipeline‑parallel configuration in which successive Transformer blocks are assigned to successive processing elements, a data‑parallel configuration in which different request batches are assigned to different processing elements or groups of processing elements, or a context‑parallel configuration in which context partitions are assigned to different processing elements.

7. The method of claim 1, wherein selecting the placement plan comprises applying a fallback policy, the fallback policy comprising:
responsive to a determination that arithmetic throughput of the first processing element is saturated, assigning computational parts to the second processing element; and
responsive to a determination that off‑chip memory bandwidth of the second processing element is depleted, assigning computational parts to a tensor‑parallel configuration distributed across a set of processing elements of the first type.

8. The method of claim 1, wherein the decomposing is agnostic to attention variant of the model, the attention variant being one of multi‑head attention, multi‑query attention, grouped‑query attention, or multi‑latent attention.

9. The method of claim 1, wherein transmitting the intermediate results comprises transmitting output vectors produced by the second computational part without transferring session‑specific state from off‑chip memory coupled to the second processing element to memory of the first processing element.

10. The method of claim 1, wherein transmitting the intermediate results comprises encapsulating the intermediate results into network packets routed over a switching fabric that couples the first processing element and the second processing element across separate chassis or racks.

11. An apparatus for serving inference requests to a large language model, the apparatus comprising:
a first processing element of a first type and including a first memory adapted to store model weights and to execute a first computational part of the model;
a second processing element having a type or resource profile different from that of the first processing element and including a second memory, distinct from the first memory, adapted to store session‑specific state and to execute a second computational part of the model;
an interconnect interface coupling the first and second processing elements and dimensioned to transfer intermediate results between the first and second processing elements; and
a scheduler circuit or executable control logic configured to:
(a) obtain resource attributes for each processing element,
(b) assign computational parts of the model to respective processing elements based on the resource attributes, and
(c) coordinate execution of the assigned computational parts so that, in response to an inference request, the apparatus produces one or more output tokens.

12. The apparatus of claim 11, wherein the first processing element is a graphics‑processing unit and the second processing element is a neural‑processing unit.

13. The apparatus of claim 11, wherein the first processing element is a graphics‑processing unit and the second processing element is a language processing unit.

14. The apparatus of claim 11, further comprising an optimization layer interposed between a large‑language‑ model serving software stack and a hardware abstraction layer, the optimization layer configured to intercept a computation graph generated by the serving software stack and to emit one or more just‑in‑time kernels targeting the first processing element and the second processing element.

15. The apparatus of claim 11, further comprising a non‑transitory computer‑readable storage medium storing a resource characterization matrix, the resource characterization matrix populated by polling the first processing element and the second processing element for immutable resource descriptors comprising on‑chip static‑random‑ access‑memory capacity, off‑chip memory type and size, sustained memory bandwidth, arithmetic throughput expressed in operations per second, and interconnect bandwidth, wherein the scheduler circuit or executable control logic is configured to consult the resource characterization matrix when obtaining the resource attributes.

16. The apparatus of claim 11, wherein the scheduler circuit or executable control logic is further configured to:
responsive to a determination that arithmetic throughput of the first processing element is saturated, reassign computational parts to the second processing element; and
responsive to a determination that off‑chip memory bandwidth of the second processing element is depleted, reassign computational parts to a tensor‑parallel configuration distributed across a set of processing elements of the first type.

17. The apparatus of claim 11, wherein the first computational part comprises feed‑forward layers of the model and the second computational part comprises an attention layer of the model.

18. The apparatus of claim 17, wherein the second processing element stores a session‑specific key‑value cache in off‑chip dynamic‑random‑access memory coupled to the second processing element and refrains from transferring the key‑value cache to memory of the first processing element.

19. The apparatus of claim 11, wherein the apparatus further comprises a third processing element of the first type but of a different hardware generation or vendor than the first processing element, and wherein the scheduler circuit or executable control logic is configured to assign the second computational part to the second processing element so as to relieve the first memory and a corresponding memory of the third processing element from storing session‑specific state, thereby increasing utilization of arithmetic throughput of the first processing element and the third processing element.

20. The apparatus of claim 14, wherein the optimization layer is further configured to encapsulate intermediate results into network packets for transmission over a switching fabric coupling the first processing element and the second processing element across separate chassis, and wherein a host central‑processing unit is excluded from a data path between the first processing element and the second processing element during execution of the assigned computational parts.

21. The apparatus of claim 11, further comprising non-volatile storage selected from one or more solid-state drives, network-attached storage, or storage local to the second processing element, wherein the non-volatile storage is configured to stage model weights, checkpoint shards, session-specific state, or key-value-cache spill data for execution by the apparatus.
